(19) United States
(12) Patent Application Publication
(10) Pub. No.: US 2005/0098046 A1
(43) Pub. Date: May 12, 2005

(54) Loaf cake pan assembly

(76) Inventor: Fletcher Morgan, St. Petersburg, FL (US)

Correspondence Address: JOHN S. HALE;GIPPLE & HALE, 6665-A OLD DOMINION DRIVE, MCLEAN, VA, 22101, US

(21) Appl. No.: 11/006,741

(22) Filed: Dec. 8, 2004

Related U.S. Application Data
(63) Continuation-in-part of application No. 29/195,320, filed on Dec. 10, 2003.
Application No. 29/195,320 is a continuation-in-part of application No. 29/178,855, filed on Apr. 2, 2003, now Pat. No. D487667.
Application No. 29/195,320 is a continuation-in-part of application No. 10/609,653, filed on Jul. 1, 2003.
Application No. 10/609,653 is a continuation-in-part of application No. 10/424,764, filed on Apr. 29, 2003, now Pat. No. 6,789,466.
Application No. 10/424,764 is a continuation-in-part of application No. 10/302,903, filed on Nov. 25, 2002, now Pat. No. 6,840,162.

(51) Int. Cl. A23P 1/00

(52) U.S. Cl. 99/426

(57) ABSTRACT

A dessert pan assembly for forming a compound dessert constructed with a rectangularly configured loaf pan having fluted side walls and a fluted bottom defining a cavity. A planar flange extends outward from the sidewalls of the loaf pan to support a cover member which is mounted to the loaf pan. The cover member has a smooth surfaced oblong projection defining an open ended cavity and a planar skirt which sits on the loaf pan flange and is held in place by a slideable clip which is slidably mounted on the surface of the skirt. The planar skirt extends over the loaf pan cavity and is provided with a plurality of holes overlying the loaf pan cavity to allow gases to escape from the loaf pan.

### CROSS-REFERENCE TO RELATED APPLICATIONS

This is a continuation-in-part application of U.S. Des. patent application Ser. No. 29/195,320 filed Dec. 10, 2003 which is a continuation-in-part of U.S. Des. patent application Ser. No. 29/178,855 filed Apr. 2, 2003 and U.S. patent application Ser. No. 10/609,653 filed Jul. 1, 2003 which is a continuation-in-part application of U.S. patent application Ser. No. 10/424,764 filed Apr. 29, 2003 which is a continuation-in-part application of U.S. patent application Ser. No. 10/302,903 filed Nov. 25, 2002.

### TECHNICAL FIELD OF THE INVENTION

The present invention relates generally to the field of cake baking and dessert molds. More particularly, the present invention concerns an apparatus for baking a loaf type cake or molded dessert having an oblong cavity formed therein by a loaf pan cover with the dessert having an outer fluted exterior formed by the interior of the loaf pan.

The present invention is thus directed toward an apparatus for molding cake batter, ice creams, gelatins or other desserts into an outer fluted loaf shape with an inner separate smaller shaped cavity having an oblong configuration. The invention also includes a tray having fluted side walls and a planar bottom surface which can be used to provide the base for the cake or dessert formed by the loaf pan.

### BACKGROUND OF THE INVENTION

Food molds have been used and are well known in the prior art. A common baking pan is a food mold, with an open end, a closed end and a peripheral side wall. The closed end and side wall define a hollow volume that becomes the three-dimensional shape of a food product molded by the baking pan.

Some food pans, such as a baking pan for making angel food cake, have an annular ring shaped with an open end. The hollow volume of the ring is filled with a food composition and then baked. After baking, the pan is inverted to remove the shaped food composition from the open end. Thus, the open end is used to form the bottom of the final food product.

Other food molds have a centrally located indentation at the closed end. With a mold of this type, a first food composition may be placed and formed in the open end and a second food composition may be placed in the complementary shaped indentation at the closed end. This provides an accurate fit for the second filler food composition within the first supporting food composition.

In all baking pans, it is desirable to facilitate the partial escape of moisture from the pans in order to develop a degree of porosity in the final baked product. At the same time, however, the batter must absorb some moisture to prevent excessive dehydration. It therefore becomes necessary to contain the batter at a pressure sufficient to limit the extent to which water is converted to steam, since the batter absorbs steam less easily than water, while allowing for a degree of conversion and escape. The batter must also be contained to prevent the escape of the cake itself due to its expansion during baking.

It can thus be seen that a number of devices have been used in the molding and baking of desserts to obtain molded desserts in a variety of shaped configurations as described in the prior art. However covered dual composition desserts are rare because of the complexity in preparing same.

Historically, it was known in the prior art to bake bread bowls which were semi-spherical loaves of bread into which a cavity was carved for placement of salads or soups. A conventional bread bowl is typically made by forming raw bread dough on the top of a simple inverted bowl which is then placed into the oven for baking. Bread bowls made in this manner often rise from the inverted bowl so that the same presents an uneven appearance, requiring trimming and waste.

Many prior art devices and techniques mold and bake dough of breads, batters of cakes, cookies, and other baked goods into various shapes including containers which may be used to hold other foods. For example, U.S. Pat. No. 4,812,323, issued Mar. 14, 1989, discloses a method for molding and baking cookie dough into a cup shape which can then be used to hold ice cream or other fillings in a similar manner to U.S. Pat. No. 3,296,956, issued Jan. 10, 1967, which also discloses a molding and baking apparatus for the baking of bread dough into a cup-like shape.

In U.S. Pat. No. 3,141,400 issued Jul. 21, 1964 a telescoping cake apparatus is disclosed with a center cone assembly which moves upward when the cake batter is baked forming a frustrum conical cake with a conical center cavity. A one piece strip cross link handle is secured to the upper edge of top of the expendable baking section and the cone by staples or the like.

U.S. Pat. No. 1,487,906 issued Mar. 25, 1924 is directed toward two nesting rectangular baking pans, the inner pan having flange members adapted to sit on a shelf formed in the outer pan with the composite unit being held in place by a strip of sheet metal which engages an upwardly extending flange of the outer pan.

A baked layered product with an apparatus for making same is shown in U.S. Pat. No. 3,831,507, issued Aug. 27, 1974. This baking assembly uses three baking pans to form a cylindrical bunt bowl body and lid which is placed over the body to hold the filling therein.

Similarly U.S. Pat. No. 1,852,966 issued Apr. 5, 1932 is directed toward a baking pan used for baking a cake with a hollow center so that the same can have a filling placed therein. A tapered tubular outer member has a core mold mounted thereon attached to a cover over the top of the tubular outer member.

The use of nested trays for forming shaped multiple individual baked goods is typified by the common muffin tray. Stacked or nesting trays for forming shaped baked goods such as bread are shown in U.S. Pat. No. 5,232,609 issued Aug. 3, 1993.

U.S. Pat. No. 5,948,313, issued Sep. 7, 1999 is directed toward a mold assembly for making a baked edible shell. The mold assembly is constructed of an outer mold shell and an associated inner mold shell, the outer mold shell having a curved main portion with a central opening and an outer rim extending in a plane. The inner mold shell has a curved main portion with a central chimney shaped to pass through the outer mold central opening. The outer mold opening comprises a raised circular rim with an inwardly directed flange. The outer edge of the outer mold shell is formed with a rolled-up rim. When the edible material is being cooked, a metal strip with curved ends is mounted over the rolled rim of the outer shell mold as seen in FIGS. 4 and 5C to hold both mold-shells in relative positions to eliminate expansion of the edible material during cooking.

Another reference, U.S. Pat. No. 5,226,352 issued Jul. 13, 1993 is directed toward a baking assembly which has an outer dome shaped member and an inner dome shaped member as shown in FIGS. 6 and 7. A flange extends outward from the upper edge of the outer dome member to seat the flange extending from the upper edge of the inner dome member. The flanges are held together by a C clamp or other fastening means. The inner dome shaped member is TEFLON® coated on its inside surface and outside surface allowing cake or dough to be baked in the outer dome mold and the inner mold.

Hemispherical shaped or dome cakes having dual composition are popular in Italian dessert cooking and are generally known as “Zuccotto”. These cakes are prepared by slicing previously baked sponge cake (Pan di Spagna) into thin, vertical slices, lining the interior of a bowl with plastic wrap and lining the plastic wrap in the bowl with overlapping pieces of the sponge cake slices. The slices of cake are then sprinkled with liquor and the dampened assembly is then covered with a plastic wrap and refrigerated. A center mixture of chocolate or other filling is poured into the cake lined bowl and the bottom or exposed surface of the filling is covered with other slices of cake. The entire cake is allowed to set for a number of hours, preferably overnight, inverted onto a platter and dusted with confectioners sugar. As can be seen, the process for making this cake is quite laborious in time and resources required.

It has been found desirable to mold or form desserts or cake into a fluted surfaced loaf shape which can be baked and/or frozen and marketed as a specialized cake having different components.

### SUMMARY OF THE INVENTION

The present invention is directed toward an assembly for producing a dual composition dessert or cake using a flanged baking loaf pan with fluting having a cover member formed with an oblong projection which extends into the loaf pan to form an oblong cavity in a cake baked in the loaf pan. The cover member is provided with planar shirt extending away from the periphery of the oblong projection which is seated on the flange formed on the loaf pan. A plurality of slideable locking members are slidably mounted on the planar surface of the skirt of the cover member to engage the outer periphery and lower surface of the flange of the loaf pan holding the same together. A bottom base pan having fluted sides and a planar bottom surface is used to provide a base cake layer for the dessert formed in the loaf pan.

It is an object of the invention to prepare two different composition food products formed as a single dessert.

It is still another object of the invention to provide a dessert assembly which delivers heat energy evenly to all areas of a cake being baked therein.

Yet another object of the invention is to provide a dessert assembly that is easy to use, ruggedized and reliable.

It is a further object of the invention to mold multiple food products made of cake batter or a dessert composition in a desired shape and bake or set the compositions while maintaining heat and pressure at a precise desired level.

It is yet another object of the invention to provide a dessert assembly which is easily broken into individual components and is easy to clean.

Another object of the invention is to provide a dessert assembly for simultaneously baking multiple food products formed of two cakes of different sizes with one cake fitting into a cavity formed during the baking process in the outer cake to produce a composition uniform cake that is predictable and reproducible without size variance.

Still another object of the invention is to provide a dessert assembly that has one or more of the characteristics discussed above but which is relatively simple to use and requires a minimum of cooking skills.

In the accompanying drawings, there is shown illustrative embodiments of the invention from which these and other objectives, novel features and advantages will be readily apparent.

These and other objects, advantages, and novel features of the present invention will become apparent when considered with the teachings contained in the detailed disclosure along with the accompanying drawings.

### BRIEF DESCRIPTION OF THE DRAWINGS

FIG. 1 is an exploded perspective view of the loaf pan assembly;

FIG. 2 is a side elevational view of the covered loaf pan shown in FIG. 1, the other side view being identical;

FIG. 3 is a top plan view of the loaf pan of FIG. 2;

FIG. 4 is a bottom plan view of the loaf pan of FIG. 2;

FIG. 5 is an end elevational view of the loaf pan of FIG. 2, the other end being identical;

FIG. 6 is a broken away view of FIG. 5 showing the oblong projection of the cover member inside the cavity of the loaf pan;

FIG. 7 is an enlarged partial cross sectional view of the cover locking assembly over the loaf pan showing motion of the same in phantom to unlock the assembly;

FIG. 8 is an enlarged partial cross sectional view of the rim of the base pan (flange) taken along line 8′-8′ on FIG. 10;

FIG. 9 is a top plan view of the base pan of the loaf pan assembly of FIG. 1; and

FIG. 10 is an side elevational view of the base pan shown in FIG. 9.

### DETAILED DESCRIPTION OF THE INVENTION

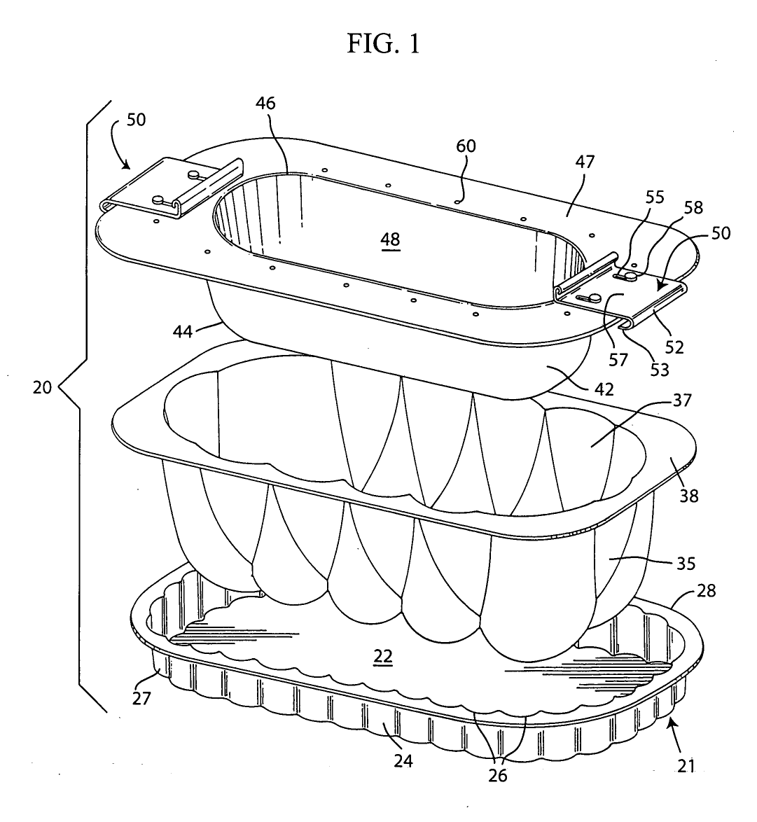

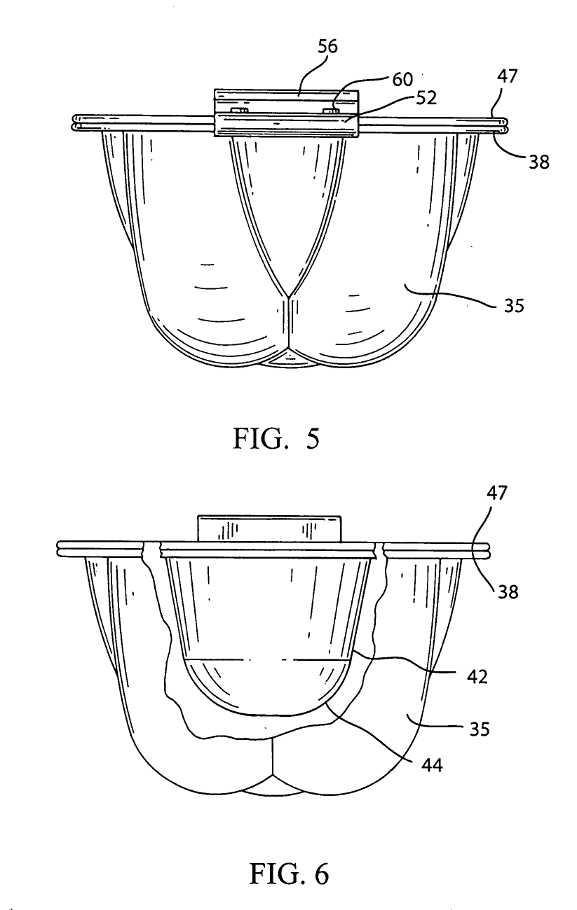

The preferred embodiment and best mode of the invention is shown in FIGS. 1 through 10 with the components of the loaf pan being shown in the FIGS. 2 through 7. The term “batter” as used herein in the application is meant to encompass cake batter, dough, malleable ice cream, gelatin or a malleable dessert which sets up in a rigid or semi-rigid shape.

Referring to the Figures, a loaf pan assembly 20 according to the invention is adapted to shape or mold batter for a composite cake or other multiple compositions of baked goods or complimentary desserts such as ice cream, gelatins, puddings into a loaf shaped dessert with a fluted outer surface having a smooth oblong shaped cavity with an option base formed in a base tray.

The pan assembly 20 is constructed with a substantially rectangular shaped tray 22, having rounded corners and formed with a planar bottom sheet 23 having sidewalls 24 defining a plurality of flutes 26. A planar rim or flange 28 extends outward from the upper end of the sidewalls 24 around the periphery of the tray parallel to the bottom sheet 23. The sidewalls are rounded at each corner 27 so that a continuous sidewall is formed. A loaf pan 30 with a cover 40 as seen in FIGS. 1 through 6 is used to bake or prepare the composite dessert. The loaf pan 30 is constructed with a generally rectangular shaped body 32 having fluted sidewalls 34, fluted end walls 35 and a fluted bottom 36 to define a cavity 37. The sidewalls 34 and end walls 35 at the open end extend outward to form a planar flange 38 upon which a corresponding skirt 47 of the cover member 40 is seated. The rim 39 of the flange 38 is curved over to form a closed rounded end as is seen in FIG. 4.

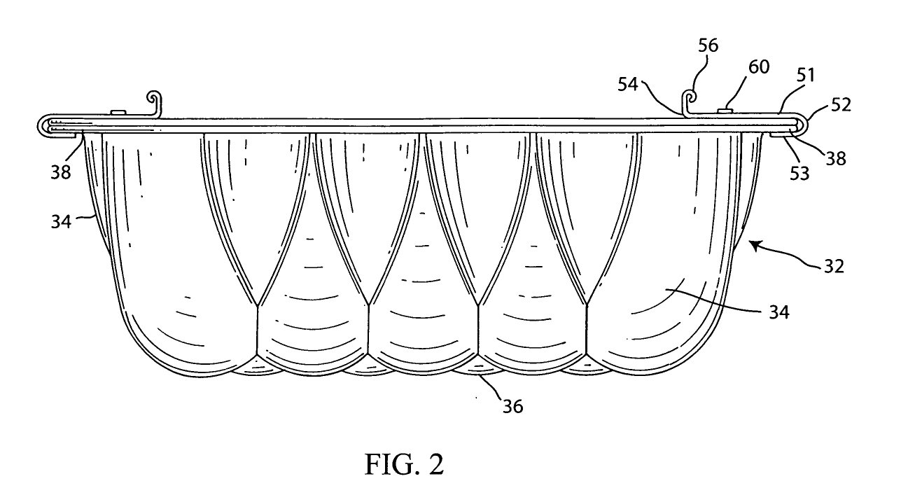

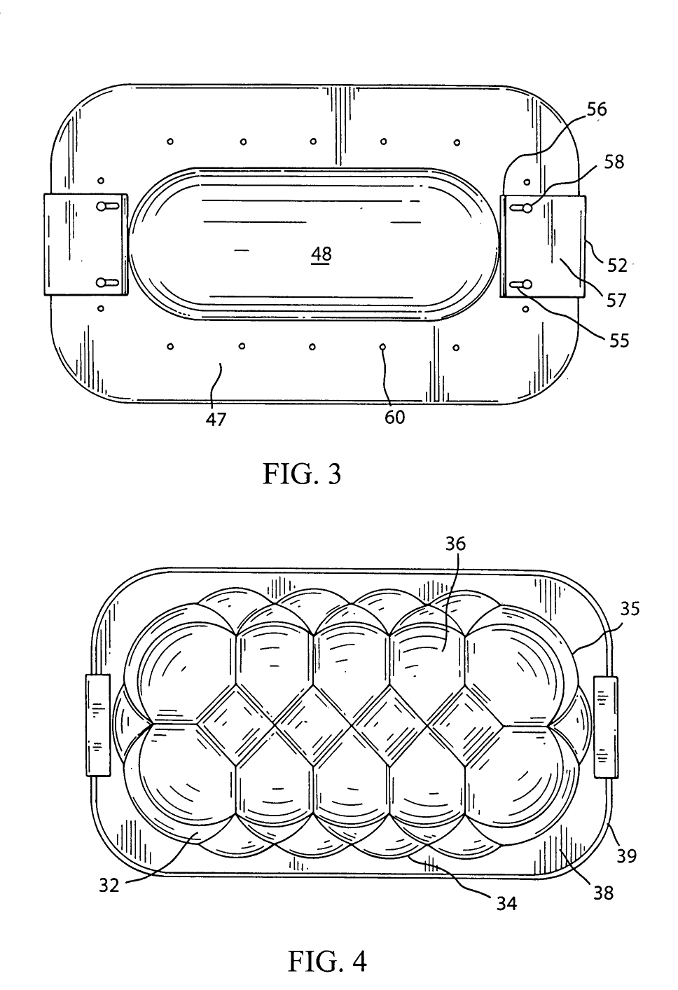

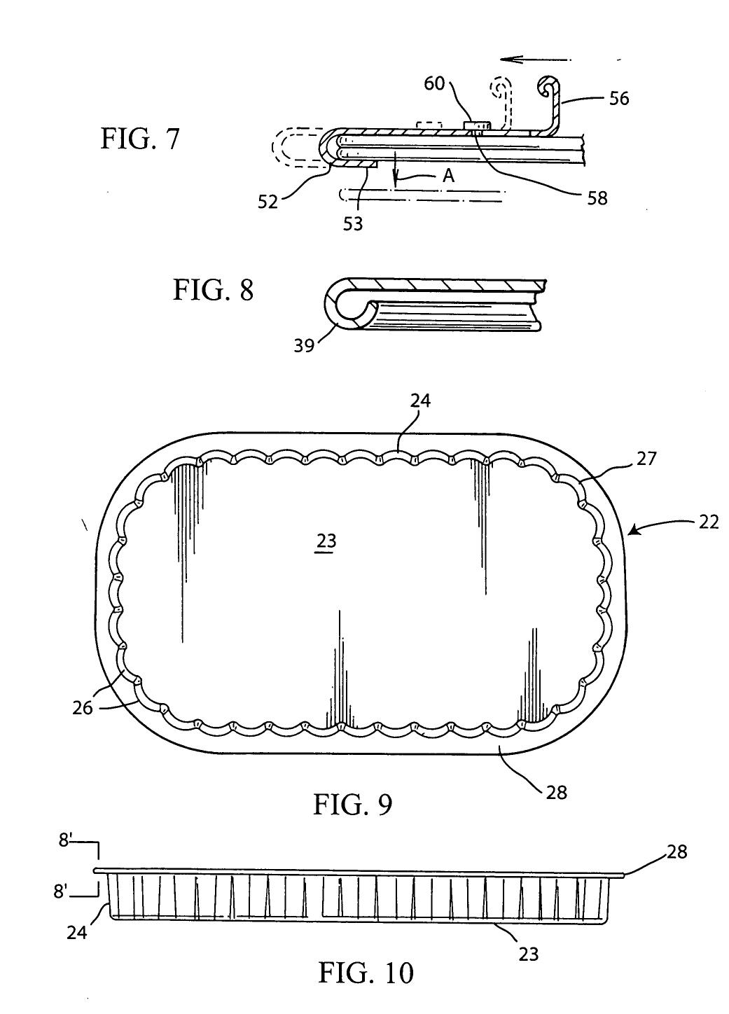

The cover member 40 has a integral oblong shaped bowl 42 with a smooth inner and outer surface and an integral outwardly extending skirt or flange portion 47 as shown in FIGS. 1, 3 and 6. The inner bowl 42 is typically symmetrical with an oblong shape having a curved closed bottom surface 44 and an open end 46 defined by outwardly extending flange 47 to form chamber or cavity 48. The bowl 42 extends away from the flange portion 47 allowing it to be seated in chamber or cavity 37 of the loaf pan 30. The planar skirt 47 is provided with sliding lock means 50 which are shaped to fit over the flange 38 of the loaf pan. The skirt 47 covers the outer surface of the cavity 48. One end 52 of the lock member body 51 is rolled or bent in a “C” configuration as shown in FIGS. 1, 2 and 5 so that the bottom portion 53 of the curved end 52 fits under the lower surface of flange 38 when the side member 50 is moved inward to lock the same in a fixed position. The open position is shown in phantom in FIG. 7. At the other end of lock member body is an integral push bar 56 that extends upward from the planar flange surface. Posts 58 are secured to the upper surface of skirt 47 and extend through slots 55 cut through the slide member body 51. Each post is provided with a head 60 having a greater diameter than the width of slot 55. Each push bar 56 is positioned in a reverse orientation from that of the opposing end 52. A plurality of throughgoing apertures 60 are spaced around the cover in the skirt portion 47 as shown in FIGS. 1 and 3 to allow steam to escape from the cake batter during the cooking process.

The loaf pan 30, cover 40 and tray 20 are preferably constructed of sheet steel or stainless steel but can be constructed of copper, aluminum, cast iron, pyrex, glass, porcelain, ceramic or any type of microwaveable material at a uniform desired thickness commonly used for baking pans and containers. If desired, the loaf pan body can have its external surface coated with a non-corroding material such as tin or chromium. The tray and its respective fluted sides may be constructed of a single sheet of metal formed into the desired shape. The inside and outside surface of cover member 40 and the fluted loaf pan 30 and the surfaces of tray 21 are preferably coated with one or more nonstick coatings, such as for example TEFLON® (i.e., fluorocarbon polymers), (e.g., tetrafluroethlene and fluorinated ethylene propylene) in the preferred embodiment to ease the removal of the baked or chilled product from the bowl. It will be appreciated by those skilled in the art that other shapes and geometries of pan assemblies are possible, and that the specifics of material of which it is made can be changed without departing from scope of the invention. The tray 22 and loaf pan 30 with cover 40 can be stamped from a solid piece of material or spun from aluminum instead of formed from a sheet.

As previously noted, the interior surface and outside surface of the each configuration which contacts the batter or dessert composition is covered with TEFLON® in the preferred embodiment to ease the removal of the baked or chilled product from the bowl. The sloping of the inner wall of the loaf pan cavity and cover member oblong bowl and cavity further eases removal of the final dessert composition. It will be appreciated by those skilled in the art that other shapes and geometries of pan assemblies are possible, and that the specifics of material of which it is made can be changed without departing from scope of the invention.

In operation cake batter is poured into the tray 22 and into in loaf pan cavity 37 about ⅔ to ¾ full. A second cake batter of a different flavor as for example chocolate is poured in the cavity 48 of the cover about ⅔ to ¾ of the depth of each bowl.

After the batter is molded and baked by the application of heat, the tray 22 and loaf pan 30 are removed from the oven. The TEFLON® coating of the interior and exterior surface of the loaf pan 30 facilitates removal of the mold without tearing or damaging the final baked product located in cavity. The smaller baked interior cake is then removed from chamber or cavity 48 of the cover assembly. The interior cake or other optional filling taken from cavity 48 is then placed in the respective cavity formed by the oblong shaped bowl 42 of the cover assembly in the cake formed in the cavity of the loaf pan and the composite assembly is inverted onto a serving area or a base cake baked in tray 22 for frosting, icing or other decoration preparatory to being served. The result is a dual composition cake or dessert which is loaf shaped or fluted and ready to eat. The baked goods may be filled or coated with ice cream, pudding, icing or other sweet filling for a dessert pastry.

Although aluminum, sheet steel and/or stainless steel is preferred for the outer bowl body, any suitable structural material, as previously identified, could be used in its place. The inner bowl body has the same material as that of the outer body.

The principles, preferred embodiments and modes of operation of the present invention have been described in the foregoing specification. However; the invention should not be construed as limited to the particular embodiments which have been described above. Instead, the embodiments described here should be regarded as illustrative rather than restrictive. Variations and changes may be made by others without departing from the scope of the present inventions defined by the following claims.

1. A dessert pan assembly for forming a dessert in a predetermined shape comprising:
a loaf pan comprising a plurality of walls and a bottom defining an open cavity and a planar flange extending outward from said walls, said flange ending in a lip extending around an outer periphery of said loaf pan and a cover member mounted on said flange, said cover member comprising an outer planar skirt and a rounded projection defining an open ended cavity extending away from said planar skirt to extend into said loaf pan cavity, said outer planar skirt being seated on said loaf pan flange and extending over said loaf pan cavity and slideable locking means mounted on said cover member adapted to selectively engage said loaf pan lip holding said cover member on said loaf pan.

2. A dessert pan assembly as claimed in claim 1 wherein said loaf pan is substantially rectangular in configuration with rounded ends and fluted end walls and fluted side walls.

3. A dessert pan assembly as claimed in claim 1 wherein said rounded projection has an oblong rounded configuration with a smooth surface.

4. A dessert pan assembly as claimed in claim 1 wherein at least one surface of said loaf pan and at least one surface of said cover member are coated with a nonstick material.

5. A dessert pan assembly as claimed in claim 4 wherein said nonstick material is tetrafluroethlene.

6. A dessert pan assembly as claimed in claim 4 wherein said nonstick material is fluorinated ethylene propylene.

7. A dessert pan assembly as claimed in claim 1 wherein said slideable locking means comprises a planar base section defining at least one throughgoing slot, post means mounted to said skirt extending through said throughgoing slot, said locking means defining end sections, each of which is integral to said planar base section and extends away from said planar base section in an opposite direction from the other end section.

8. A dessert pan assembly as claimed in claim 7 wherein a distal end of said locking means defines an endwardly curved end.

9. A dessert pan assembly as claimed in claim 1 wherein said skirt defines a plurality of throughgoing holes.

10. A dessert pan assembly as claimed in claim 7 wherein said post means comprises a transverse standard and an integral head formed at the distal end of said standard, said head having a diameter greater than the width of said throughgoing slot.

11. A dessert pan assembly as claimed in claim 1 including a base tray with a bottom planar surface and fluted side walls.

12. A dessert pan assembly for forming a dessert in a predetermined shape comprising:
a loaf pan defining a bottom member and a plurality of fluted walls secured to said bottom member forming a substantially rectangular configuration with rounded corners defining an open ended cavity, an integral planar flange extending outward from said walls, a cover member mounted on said flange, said cover member comprising an outer planar skirt and an oblong projection defining an open ended cavity, said oblong projection extending away from said planar skirt into said loaf pan cavity and slideable locking means mounted on said cover member adapted to engage a lower surface of said loaf pan flange holding said cover member on said loaf pan.

13. A dessert pan assembly as claimed in claim 12 wherein said loaf pan and said cover member are coated with non-stick material.

14. A dessert pan assembly as claimed in claim 13 wherein said nonstick material is tetrafluroethlene.

15. A dessert pan assembly as claimed in claim 13 wherein said nonstick material is fluorinated ethylene propylene.

16. A dessert pan assembly as claimed in claim 12 wherein said slideable locking means comprises a planar base section defining at least one throughgoing slot, post means mounted to said skirt extending through said throughgoing slot, proximal and distal end sections, integral to said planar base section which extend away from said planar base section in opposite directions to each other, said distal end section being curved back parallel to and towards said base section.

17. A dessert pan assembly as claimed in claim 12 wherein said skirt defines a plurality of throughgoing holes.

18. A dessert pan assembly as claimed in claim 12 including a support pan with a bottom planar surface and fluted side walls.

19. A dessert pan assembly as claimed in claim 12 wherein said bottom member has a surface which is fluted.

20. A dessert pan assembly for forming a dessert in a predetermined shape comprising:
a loaf pan defining a fluted bottom member and a plurality of fluted walls extending from said bottom member forming a rectangular configuration with rounded corners defining a cavity, a planar surfaced flange extending outward from said walls around said cavity, a cover member mounted on said flange, said cover member comprising an integral oblong projection defining an open ended cavity and an outer planar skirt extending away from said oblong projection defining a plurality of spaced apertures, said oblong projection being adapted to extend into said loaf pan cavity when said skirt is seated on said loaf plan flange and slideable locking means mounted on said cover member adapted to engage a lower surface of said loaf pan flange holding said cover member on said loaf pan; said slideable locking means comprising a planar base section defining at least one throughgoing slot, post means mounted to said skirt extending through said throughgoing slot, end sections integral to said planar base section which extend away from said planar base section in opposite directions to each other, a distal end section being curved back towards and parallel to said planar base section; and
a support pan with a bottom planar surface and fluted side walls.
